(19) United States
(12) Patent Application Publication
(10) Pub. No.: US 2011/0142137 A1
(43) Pub. Date: Jun. 16, 2011

(54) VIDEO PROCESSING

(75) Inventors: RICHARD T. LEIGH, WINCHESTER (GB); MICHAEL A. RICKETTS, WINCHESTER (GB)

(73) Assignee: INTERNATIONAL BUSINESS MACHINES CORPORATION, ARMONK, NY (US)

(21) Appl. No.: 12/961,127

(22) Filed: Dec. 6, 2010

(30) Foreign Application Priority Data
Dec. 16, 2009 (EP) 09179464.4

(51) Int. Cl. H04N 11/02

(52) U.S. Cl. 375/240.18; 375/E07.114

(57) ABSTRACT

A video stream comprising a plurality of sequential frames of pixels is processed. For each pixel in a frame, a pixel data stream comprising the color components of the specific pixel is extracted from each frame with a processor. For each pixel data stream, a transformation of the pixel data stream into a plurality of detail components is performed with the processor. From each transformed pixel data stream, a detail component defining a lowest level of detail for the respective pixel data stream is collected with the processor. The collected lowest level of detail components is stored, sequentially in a primary block. At least one additional block containing remaining detail components is generated.

### BACKGROUND

This invention relates, in general, to video stream processing, and in particular, to compressing video data.

An image that is displayed by a device such as an LCD display device is comprised of pixel data which defines the output of the display device on a per pixel level. The pixel data can be formatted in different ways, for example, traditionally using RGB levels to define the ultimate color of the actual pixel. Moving images (video) are produced by displaying a large number of individual images (frames) per second, to give the illusion of movement. Video may require 15, 25 or 30 frames a second, for example, depending upon the video format being used. The increasing resolution (pixels per frame) of source video and display devices means that a large amount of pixel data is present for a given video stream, such as a film, and that a higher bandwidth (data per second) is required to transfer the video data from one location to another, for example, in the broadcast domain.

To reduce the data and bandwidth demands, video compression is commonly used on the original frame and pixel data. Video compression reduces the amount of data present without appreciably affecting the quality of the end result for the viewer. Video compression works on the basis that there is a large amount of data redundancy within individual frames and also between frames. For example, when using multiple frames per second in video, there is a significant likelihood that a large number of frames are very similar to previous frames. Video compression has been standardised and a current common standard is MPEG-2, which is used in digital broadcast television and also in DVDs. This standard drastically reduces the amount of data present from the original per pixel data to the final compressed video stream.

Large media files (containing video and audio) are frequently transferred around the Internet. The advent of so-called “On-Demand” services of high definition video content places considerable strain on central servers, and so the concept of a peer-to-peer (P2P) file transfer was introduced to share load between all interested parties. This technique is currently used for example in the BBC iPlayer download service. However, the stream oriented approach of current video and audio encoders does not mesh well with the random access distribution method of P2P transfers. Decoding a partially completed media file using current approaches leads to some portions at the maximum quality for a given compression approach, and no information for other portions.

### BRIEF SUMMARY

According to one embodiment of the present invention, there is a method of processing a video stream comprising a plurality of sequential frames of pixels. For each pixel in a frame, a pixel data stream comprising the color components of the specific pixel is extracted from each frame. For each pixel data stream, a transformation of the pixel data stream into a plurality of detail components is performed. From each transformed pixel data stream, the detail component defining the lowest level of detail for the respective pixel data stream is collected. The collected lowest level of detail components is sequentially stored in a primary block. At least one additional block containing the remaining detail components is generated.

According to one embodiment of the present invention, there is provided a system for processing a video stream comprising a plurality of sequential frames of pixels. A processor is arranged to extract, for each pixel in a frame, a pixel data stream comprising the color components of the specific pixel from each frame. For each pixel data stream, a transformation of the pixel data stream into a plurality of detail components is performed. From each transformed pixel data stream, the detail component defining the lowest level of detail for the respective pixel data stream is collected. The collected lowest level of detail components is stored sequentially in a primary block, and at least one additional block containing the remaining detail components is generated.

According to one embodiment of the present invention, there is provided a computer program product on a computer readable medium for processing a video stream comprising a plurality of sequential frames of pixels. The product comprises instructions for extracting, for each pixel in a frame, a pixel data stream comprising the color components of the specific pixel from each frame. For each pixel data stream, a transformation of the pixel data stream into a plurality of detail components is performed. From each transformed pixel data stream, the detail component defining the lowest level of detail for the respective pixel data stream is collected. The collected lowest level of detail components is stored sequentially in a primary block, and at least one additional block containing the remaining detail components is generated.

### BRIEF DESCRIPTION OF THE SEVERAL VIEWS OF THE DRAWINGS

FIGS. 1-3 are schematic diagrams of the processing of a video stream;

FIG. 4 is a schematic diagram of a distribution path of the video stream;

FIGS. 5-10 are schematic diagrams of processing of a video stream in accordance with an embodiment the present invention; and

FIGS. 11-12 are schematic diagrams of a reconstruction of the video stream in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In an embodiment of the invention, video processing will support the generation of an entire video stream from a primary block, with all additional blocks improving the quality of the video stream, without the need for the additional blocks to be received in any particular order. The invention makes possible video transmission by per-pixel lifetime encoding. By considering the lifetime of an individual pixel over the entirety of the source material, successive approximations are made. These approximations are such that a (probably bad) estimate of the colour of the pixel can be made throughout the entire movie from very little seed information.

To understand the principle of the invention, in a trivial implementation consider sending the start and end colors of a pixel. Then, for any frame in the film, a value can be calculated through linear interpolation. If the midpoint pixel value is now added, then all the values in the first half, and all the values in the second half of the film are now probably a little closer. With the quartiles added, a closer approximation of the original signal can now be generated. It is clear that it is better than the starting approach, since initially it would only be possible to know that two pixels were faithful to the original, as now five are known. However, if there were only the second quartile pixel without the first, then only the second half of the video stream would be more accurate. This is the conceptual basis of using randomly received data to generate increasingly more faithful reconstructions of a source signal, while at all times being able to generate some kind of output signal.

Other than being able to construct a complete video stream from random access transmission schemes, another key advantage of this approach is the stream processing/parallelization that this method brings. With a frame based stream sequence, encoding and decoding are generally very dependent on prior results. With the present invention, not only are all pixels independent of each other, but other than at easily identified crossover points, encoders and decoders can work on the same time sequence independently of each other.

Preferably, the step of performing, for each pixel data stream, a transformation of the pixel data stream into a plurality of detail components, comprises performing successive discrete wavelet transforms on each pixel data stream. A good method of transforming the pixel data streams to detail components is to use discrete wavelet transforms to extract levels of detail from the pixel data streams. Each pass of discrete wavelet transforms separates the data into an approximation of the original data (the lowest level of detail) and local information defining higher levels of detail. The original pixel data stream can be reconstructed from the lowest level of detail with each additional piece of detail information improving the quality and accuracy of the end result.

Advantageously, the method further comprises receiving an audio stream, separating the audio stream into frequency limited streams, performing, for each frequency limited stream, a transformation of the frequency limited stream into a plurality of audio detail components, collecting, from each transformed frequency limited stream, the detail component defining the lowest level of detail for the respective frequency limited stream, storing in the primary block the collected lowest level of audio detail components, and generating one or more additional blocks containing the remaining audio detail components.

Audio data can be considered as a single signal throughout the video sequence (or more accurately, two signals for stereo or six for 5.1 surround sound). Initial tests show, however, that dividing the signal by frequency and encoding several different frequency bands produces a more philharmonious result. Likewise, transforming the video signal from RGB components into YCbCr allows the use of the common video encoding trick of discarding half of the color information while preserving the more perceptually important brightness information.

YCbCr is a family of color spaces used as a part of the color image pipeline in video and digital photography systems. Y is the luminance (luma) component (brightness) and Cb and Cr are the blue-difference and red-difference chrominance (chroma) components (color information).

Inspection of the resultant wavelet transform space reveals large areas where luminance (Y) and chrominance (CbCr) do not change rapidly, which is represented by a series of zeros in high detail areas of the transform. Essentially, these contribute nothing to the resultant recomposition as convolving it with a kernel, results in a zero contribution to the sum of a given pixel. It is analogous to using a very high sample rate on a slowly changing signal. Additionally, some nonzero information, while needed for perfect reconstruction, may not be needed for perceptual reconstruction. That is, the corrections to the underlying signal might be ignored if they do not significantly adjust the signal. This will again manifest itself as small values in wavelet space, since their overall contribution to the reconstructed signal will be proportionally small. By truncating low values, further information can be discarded.

As the threshold at which data is discarded can be set at any level, this encoding scheme may be used to compress any signal regardless of length down to a minimum of 15 to 25 (a number between 3×kernel width/2 and 5×kernel width/2) samples per signal and therefore of the order of a few kilobytes for a full film, up to a lossless and perceptually lossless depending on the application. Many scenarios can be envisaged where getting a bad quality video using limited bandwidth but that further detail can be added without needing retransmission would be useful, for example, deciding whether to discard or receive a video from a probe on Mars.

In a preferred implementation, a naive threshold filter is used, however any image and signal processing “significance” algorithms can be used, including adaptive ones that for example, drop detail during, for example, advertisements or credits, and provide more bandwidth during, for example, action scenes. This is made possible since for a given sample in wavelet space it is possible to determine precisely from which samples in the original stream it was derived and will influence during reconstruction.

The resultant set of decompositions can be appended to each other, and encoded as a sparse vector for transmission. By ignoring a series of insignificant data (zero, or below the threshold), then as soon as a significant data is seen, its offset is stored, and all the data up to a subsequent stream of insignificant data is stored. From this, by assuming the wavelet space is mostly zeros, then this encoding with overhead for an offset will be more efficient than transmitting the long runs of zeros present in the original.

To construct an encoded video, a header consisting of various metadata (height, width, title, frame count etc.) is written, followed by the seed data that permit any pixel/audio channel to be badly reconstructed at any time code. After this, the chunks of wavelet space offset and significant data are then randomly distributed throughout the remainder of the file.

Present P2P applications can prioritize the first segment of a file, and so the section with all this seed information can be reasonably guaranteed to be present. Thereafter, any other random sample of data from the remainder of the file will provide further detail about a (random) pixel/sound track in the movie. The random access nature of this approach means that a complete copy of the data must be stored in memory, since decoding a single frame is as difficult as decoding the entire movie. However, as modern graphics cards approach 2 GB of memory, and stream processors such as the cell approach 320 GB/s bandwidth, this is not seen as a limiting factor, especially in light of the advantages brought by the parallel stream processing this approach provides.

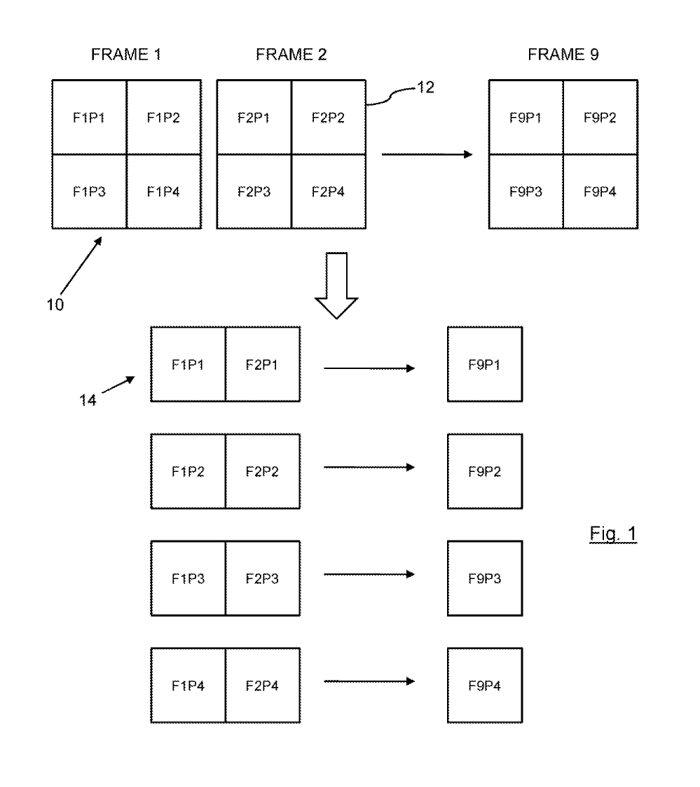

The principle of the invention is illustrated in FIG. 1, which shows a video stream comprising a plurality of sequential frames, such as frame 10, having a number of pixels, such as pixel 12. In this example, the video stream comprises nine frames 10 of four pixels 12 each. This example is shown to illustrate the principle of the processing of the video stream that is carried out. In reality, a video stream to be processed will comprise many thousands of frames and each frame will comprise many thousands of pixels. A high definition film, for example, will contain upwards of 180,000 individual frames, each of 1920×1080 pixels (width times height of pixels in each individual frame).

The four pixels 12 in each frame 10 are numbered P1 to P4, although normally pixels will be addressed using x and y co-ordinates. Therefore, frame 1 comprises four pixels F1P1, F1P2, F1P3 and F1P4. Subsequent frames 10 also have four pixels numbered using the same system. It is assumed that every frame 10 has the same number of pixels 12 in the same width and height matrix. Each pixel 12 is comprised of color components that define the actual color of each pixel 12 when it is ultimately displayed. These may be red, green and blue values (RGB) which define the relative intensity of the color components within the pixel. In display devices such as LCD display devices each pixel is represented by three color outputs of red, green and blue, controlled according to the pixel data 12.

FIG. 1 shows the first stage of the processing of the video stream. There is extracted, for each pixel 12 in a frame 10, a pixel data streams 14 comprising the color components of the specific pixel 12 from each frame 10. Since there are four pixels 12 in each frame 10, there will be four pixel data streams 14 once this extraction process has completed. Essentially, this step switches the video stream from a per-frame representation to a per-pixel representation. Each pixel data stream 14 contains the color information for a specific pixel 12 throughout the entirety of the video sequence represented by all of the frames 10.

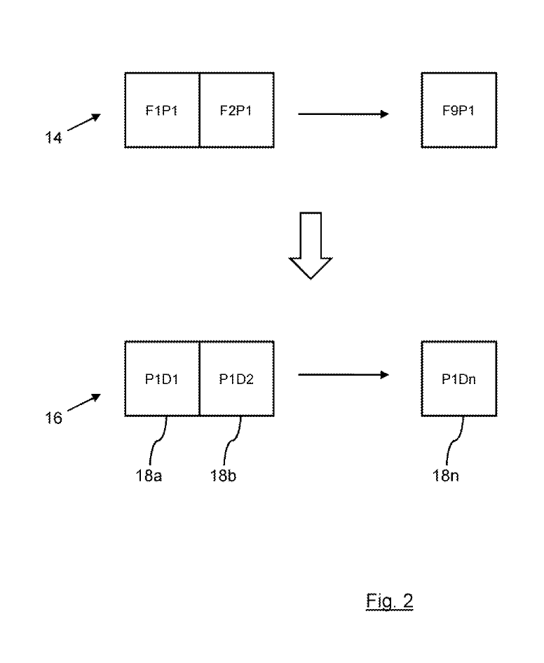

The next processing stage is illustrated in FIG. 2, where there is performed, for each pixel data stream 14, a transformation of the pixel data stream 14 into a transformed pixel data stream 16 comprising a plurality of detail components 18. Each of the four pixel data streams 14 from FIG. 1 are transformed as shown in FIG. 2 into a transformed pixel data stream 16. The transformed pixel data stream 16 has detail components 18 from D1 to Dn. There is not necessarily the same number of detail components 18 as there were pixels 12 in the pixel data stream 14. The number of detail components within the transformed pixel data stream 16 will depend on the transformation process.

In an embodiment, the Discrete Wavelet Transform (DWT) is used for the transformation process, given its proven suitability in other applications such as JPEG2000. With each pass of the DWT the source signal is split into two halves; an approximation signal, and a detail signal. Performing successive DWTs on the approximation signal very rapidly reduces the length of that signal. For example, after 10 passes the approximation signal will be about 1/1000th the length of the original, yet perfect reconstruction of the source signal is possible using the approximation signal and the remaining nine detail signals (each of which is half the length of the previous, also going down to around 1/1000th the original source).

A valuable feature of the DWT is that information in the detail layers is localized. Having a portion of a detail signal is useful during reconstruction without needing the entirety of it, unlike, for example, a polynomial decomposition. Missing data has no impact, and can safely be taken as zeros during reconstruction, thus, meeting the goal of having random data be useful when trying to reconstruct a given frame of a video stream. In the transformed pixel data stream 16 the detail component 18a is the approximation signal containing the lowest level of detail and the remaining detail components 18b to 18n are the detail signals removed with each pass of the transform.

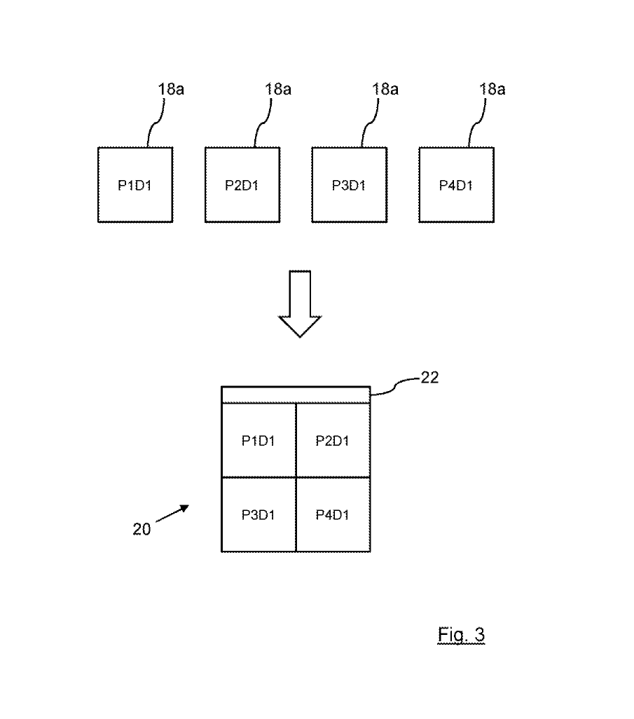

Once the processing of each pixel data stream 14 has been carried out, thereby transforming each stream 14 into a transformed pixel data stream 16, the processing is continued, as illustrated in FIG. 3. There is collected, from each transformed pixel data stream 16, the detail component 18a defining the lowest level of detail for the respective pixel data stream 14 and these are stored sequentially in a primary block 20 as a collection of the lowest level of detail components 18a. Detail components P1D1 to P4D1 are brought together and stored in the primary block 20. Theoretically, block 20 contains enough information to recreate the entire original video stream. The block 20 could be a single file or a database entry.

The block 20 is also shown as including a header 22 which can be used to store metadata about the remainder of the block 20. For example, information such as the number of frames 10 and/or the number of pixels 12 per frame 10 could be included in the header 22. This information may be needed at the decoding end of the process, when the original primary block 20 is used to create a visual output that will be displayed on a suitable display device. Other information might include the frame rate of the original video sequence and data about the specific processing methodology that lead to the creation of the primary block 20, such as the details of DWT used. Once the block 20 is transmitted and received at the decoding end of the transmission path, then the header 22 can be accessed by a suitable decoder and used in the decompression of the remainder of the block 20.

The remainder of the data that was created during the transformation process of FIG. 2 can also be brought together to generate one or more additional blocks containing the remaining detail components. Once the detail components shown in the top half of FIG. 3 have been collected and placed in the primary block 20, the remaining detail components are spread in other blocks. There is no requirement that this information be placed in any order, only that an identifier is included with each detail component in order to identify to which pixel and to which level of transformation the detail component belongs. These remaining blocks of detail components will also be used at the decompression end of the transmission path.

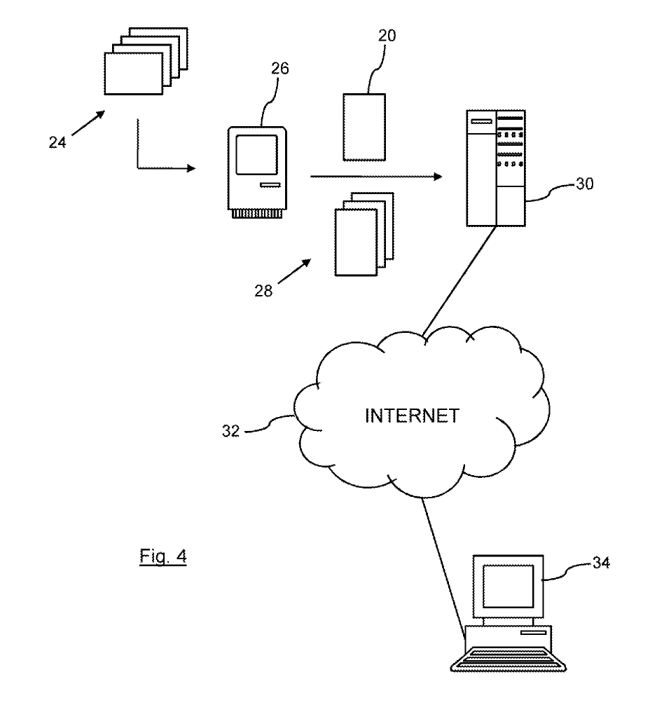

FIG. 4 shows an example of how a transmission path can be implemented for a video stream 24 of frames. The video stream 24 is processed, as described above, at a processing device 26, either in a dedicated hardware process or using a computer program product from a computer readable medium such as a DVD or a combination of the two. The output of the processing device 26 is the primary block 20 and additional blocks 28. In general there will be a large number of the blocks 28, in a practical implementation, more files is preferable to fewer files. These blocks 20 and 28 are stored by a server 30 which is connected to a network 32 such as the Internet.

The server 30 provides an on-demand service of access to the original video stream 24 through the primary block 20 and the additional blocks 28. Client computers 34 can connect to the network 32 and access the primary block 20 and the additional blocks 28 from the server 30. Once the client computer 34 has downloaded the primary block 20, then theoretically the client computer 34 can provide a video output of the entire video sequence 24, although in practical terms probably 30% of the additional blocks 28 are also required to create a sufficient quality output to be acceptable. The audio components associated with the original video sequence 24 can be processed and stored in the same fashion, which is discussed in greater detail below.

The distribution path shown in FIG. 4 can also take advantage of peer-to-peer (P2P) technologies. The client device 34 does not have to communicate with or receive information from the server 30 in order to access the original video sequence 24. For example, other connected client devices can communicate one or more of the blocks 20 and 28 directly to the client device 34, in standard P2P fashion. The client device 34 is shown as a conventional desktop computer, but could be any device with the necessary connection, processing and display functionality, such as a mobile phone or handheld computer. The original video sequence is rendered on the local device 34 after decompression (or more correctly reconstitution) of the original video 24.

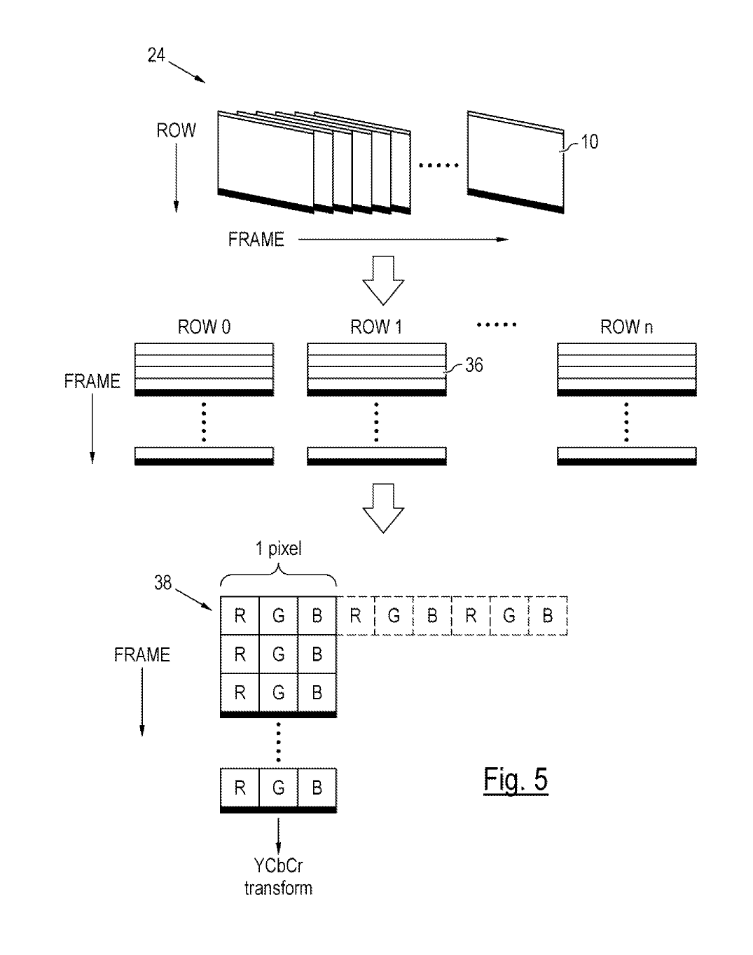

The processing described above with reference to FIGS. 1 to 3 relates to a simplified model of the processing of the video sequence 24, for ease of understanding. A more detailed version of the processing of a video sequence 24 will now be described. Such detail will provide the best result in terms of maximising the compression of the video sequence 24 and will deliver the data that is needed to provide a working solution in a practical commercial environment. This processing starts in FIG. 5. The video sequence 24 is represented as a sequence of frames 10 with an increasing frame number from left to right in the Figure. The rows of pixels are numbered downwards in an individual frame 10, row 0 being the top row of an individual frame 10 and row n being the bottom row of the frame 10 (its actual number depending upon the resolution of the frame 10. Each frame 10 is split into a row 36 of pixels and each row 36 is appended to a file corresponding to that row number. Each column in these files is the lifetime of a color component 38 of a pixel in the video sequence 24. Each pixel is extracted and converted from a color component 38 comprised of bytes in RGB format to a floating point [0.0-1.0] YCbCr format.

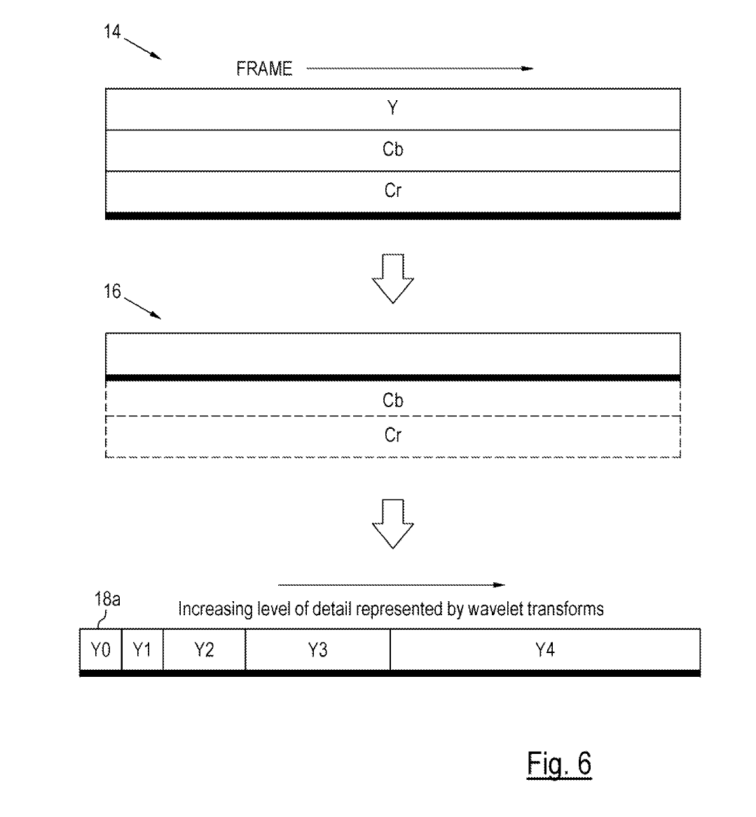

FIG. 6 shows at the top the lifetime brightness and color data for one pixel. This is the color components of a single pixel throughout the entire video sequence 24. There will be streams 14 of YCbCr data like this for every pixel in the original video sequence 24. Successive discrete wavelet transforms are then performed on each of the data streams 14 to produce a transformed pixel data stream 16. The preferred wavelet to be used is the reverse bi-orthogonal 4.4 wavelet, which was found to provide a visually pleasing result. After multiple DWTs on each stream 14, the resulting transformed pixel data stream 16 comprises the detail components 18 with increasing level of detail represented by the wavelet transforms.

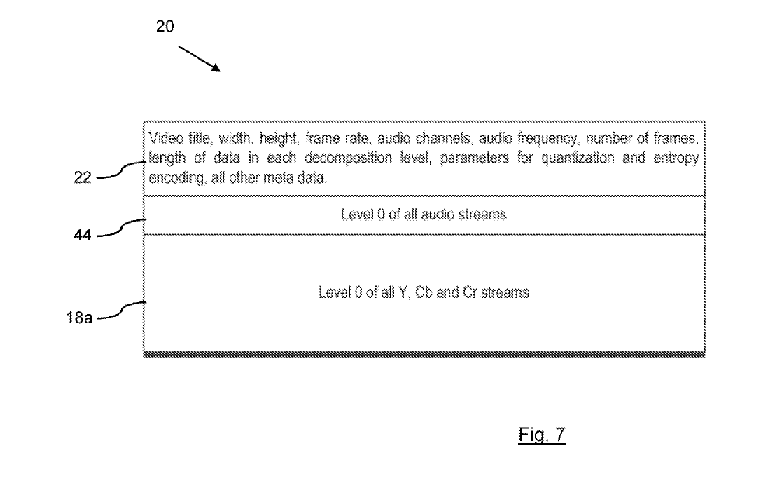

Once all of the pixel data streams 14 have been converted into transformed pixel data streams 16 then all level 0 information (Y, Cb, Cr, audio) is collected for all the streams to be encoded into the primary block 20, shown in FIG. 7. The data is quantized, and stored sequentially after a header block 22 in the primary block 20. Due to the wide range of values that must be represented during quantization from floats to bytes, a non-linear approach such as companding should advantageously be used. The header block 22 contains metadata about the original video sequence 24 and the processing method.

Audio data must be converted into individual channels (e.g. left, right, surround left, subwoofer etc.) before applying a similar DWT process. Since partial reconstruction using only mostly low frequency data may be inadequate, audio is separated into several more data streams within limited frequencies using a psycho-acoustic model, before the successive DWT process. This information can be further compressed by, for example, LZA compression to reduce the size of the critical block. Such subsequent compression is not possible for the rest of the stream data if reconstruction from partial data is to remain possible. This is stored as level 0 audio data 44 in the primary block 20.

The remaining data sets 18b, etc. become increasingly sparsely populated as well as having less impact on the final reconstruction if some parts are missing. Compression is achieved through quantization, skipping sparse areas, and entropy encoding. Using different parameters per decomposition level yields the best approach. Since the parameters must be stored in the header 22 to prevent a dependency on data in the random access area of the file, file wide instead of per stream settings for each of the decomposition levels are used, lowering the size of the header 22. Cb and Cr data can generally be very aggressively approximated.

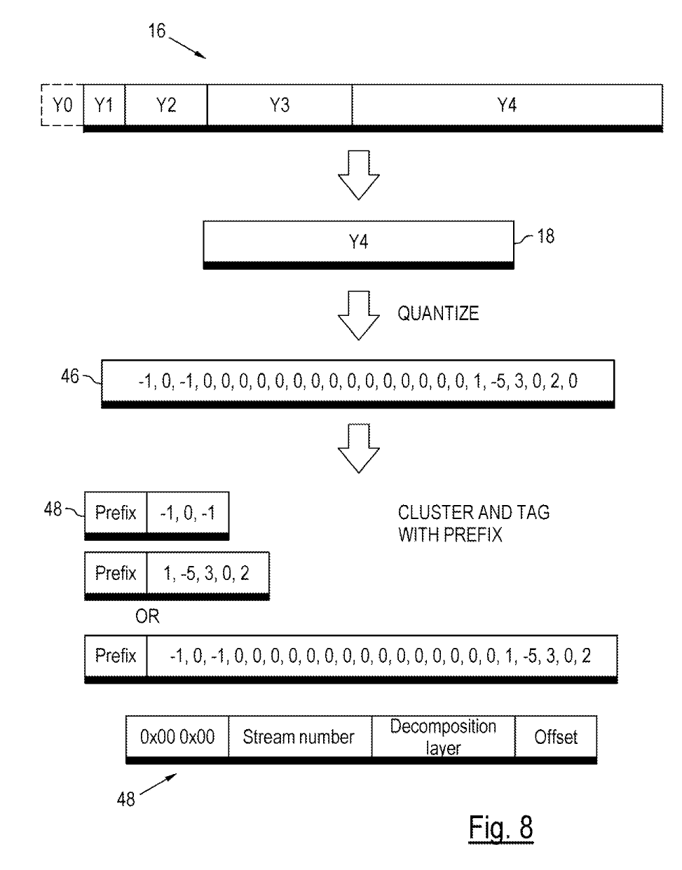

It is necessary to quantize each decomposition level 18 as shown in FIG. 8, where detail “Y4” is processed. After quantization, a quantised detail 46 is generated. Detail component 46 is then processed to find significant clusters and skip 0's. Consecutive runs of 0's are common after quantization. Clusters of significant data are found, some of which may contain 0's. The maximal number of 0's to incorporate before starting a new chunk is determined by the size of the chunk prefix and how large the data is after entropy encoding. A practical upper limit on the size of a chunk is the size of a work unit used during transmission. The detail component 46 is clustered and tagged with a prefix 48.

The prefix 48 starts with a sentinel 0x00, 0x00 must not appear in any encoded data, stream number, decomposition layer or offset, therefore being reserved for this function. The stream number is a means of identifying to which Y/Cb/Cr/Audio stream the data relates. This is shared between all decomposition layers derived from this stream. To avoid 0x0000 appearing, value ranges are limited to 30 bit representations, and then split into groups of 15 bits with 1 bit as padding during serialisation, thus ensuring there are never sequences of 16 0 bits in a row. The offset data defines how far into the decomposition layer this chunk's first member appears.

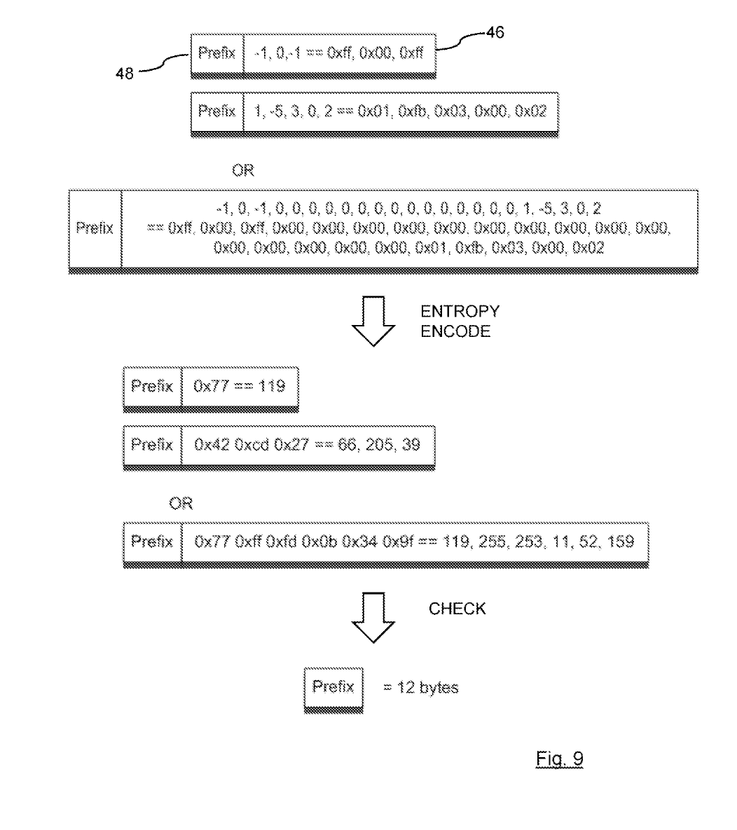

Each data section 46 is then entropy encoded, for example, by using sign aware exponential Golomb encoding. This is illustrated in FIG. 9, where a data section 46 is entropy encoded (where 0x0000 is prevented from appearing when encoding quantized values [−126, 126] bijected to [0, 252] as at most 15 0 bits may occur after encoding 128 and before encoding any other number greater than 127). Therefore the end result is an encoding of the stream as 1×12 byte prefix 48 and 6 bytes of entropy encoded data 46, instead of 2×12 byte prefixes and 4 bytes of entropy encoded data. The sequence of 0's would need to be about 96 longer in this example to cause a switch.

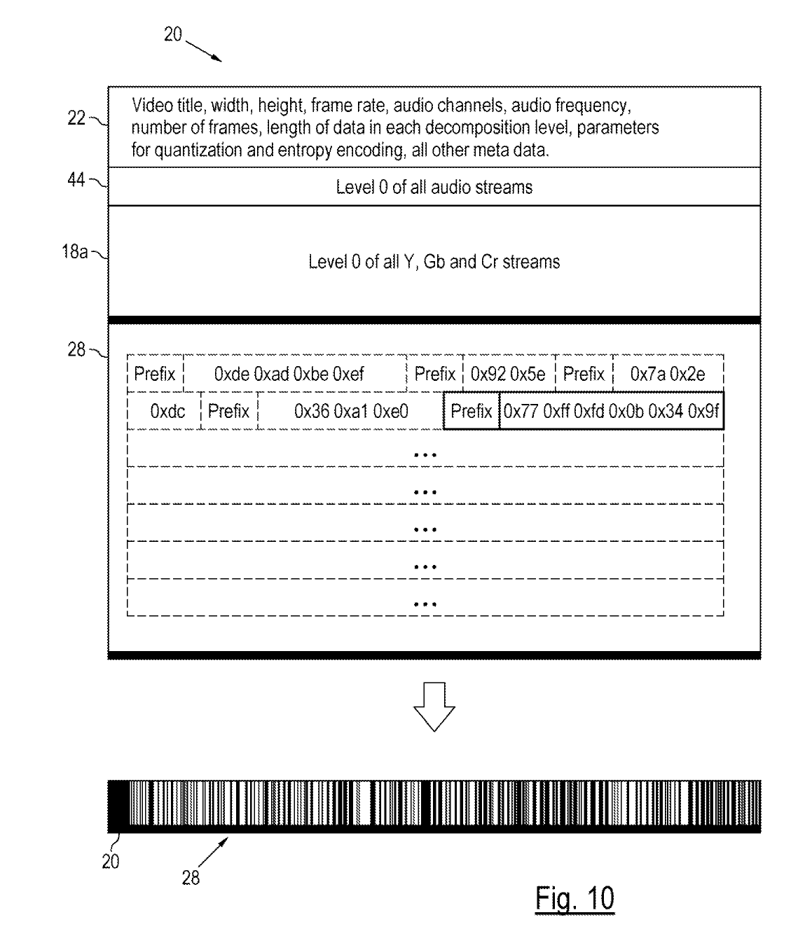

The processing of the original video sequence 24 is now complete. FIG. 10 shows the final structure of the data after the video sequence 24 has been processed. All of the other chunks of data are gathered together in a random order and written to disk as the additional blocks 28. The data can be distributed using P2P technology/other mechanism, where random parts of the main data section may be missing, but the critical data (header, Level 0 data) of the primary block 20 can be assured. The critical data has been acquired by prioritising first sections of the data. The rest of the data (the components 28) continues to arrive in random chunks. The primary data block 20 and the additional blocks 28 can be stored together as a single file or spread between multiple files, depending upon the implementation of the video processing.

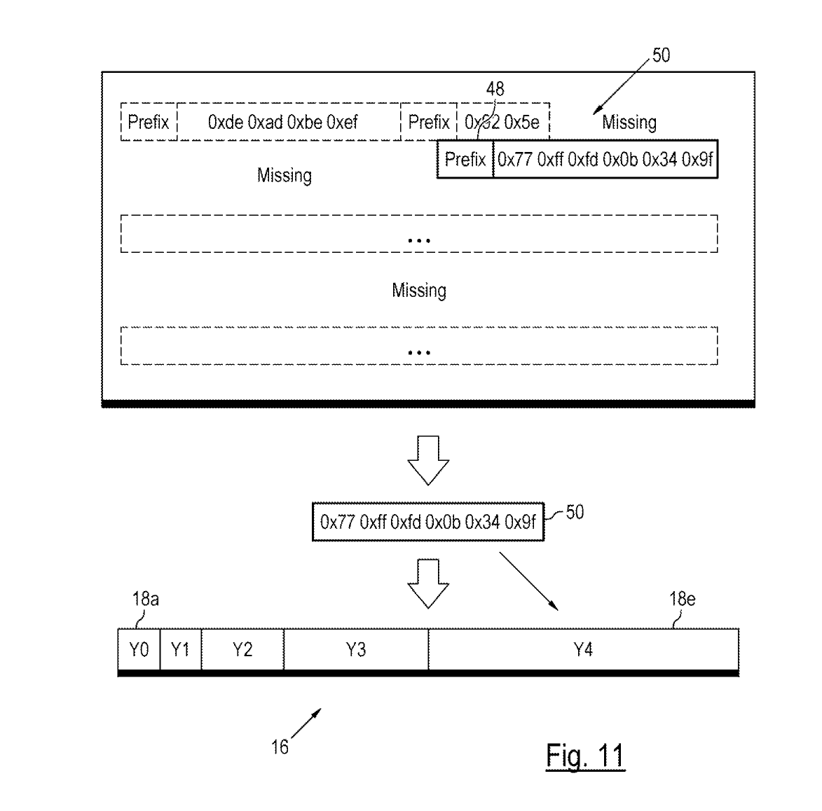

The receiving device 34, at the end of the transmission path, which will display the video sequence 24 can decode and play back the video 24 by reversing the process described above. The receiving device 34 will have the primary block 20 and will be receiving one or more further blocks or data packets relating to the video sequence 24, as is shown in FIG. 11. The receiving device 34 will detect the 0x00, 0x00 sequence in the data. Received component 50 is recognized from the 0x00, 0x00 sequence in the prefix 48. From the stream number, decomposition level, and offset contained in the prefix 48, it is possible to work out where to unpack the data in a memory representation of wavelet recomposition arrays.

In the example of FIG. 11, the received component 50 is identified from its prefix 48 as being the Y4 detail component 18e of a specific transformed pixel data stream 16. This is decode from entropy encoding, and converted from quantized bytes back to floating point representation. Y4 was filled with 0's (prior to the receipt of the component 50), now some parts of it (or some more parts of it, or even all of it) have useful data. Y0 was already fully available from critical data of the primary block 20. Y3, for example, is still all 0s. There is identified that one or more remaining detail components is missing and they are replaced with a run of zeros. The receiving device 34 will reconstruct the data as best as possible. It is the user's choice whether to use high level data when mid level data is missing, which improves scene change detection and audio crispness but increases average error.

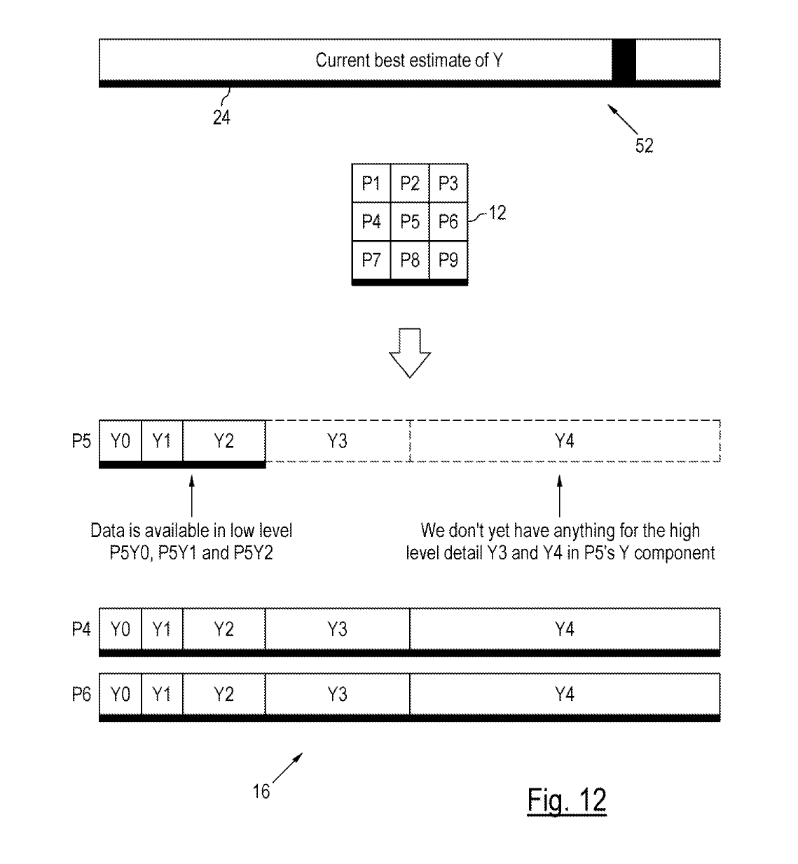

The decoded data streams 16 have Inverse Discrete Wavelet Transform performed on them. However, completely reconstructing the original signal is not necessary to acquire a specific sample from the data stream for a given frame number. Absent data has been filled in with 0's. As long as Level 0 data is present, reconstruction of some approximate signal is always possible. As shown in FIG. 12, decoding a particular portion 52 of the timeline for a data stream only requires a narrow slither of data from each decomposition level. Proportionately however, the final value that is decoded is influenced more by low level decomposition data, and the same slither of data in lower decomposition levels is used in the recomposition of many more pixels than a window the same width in higher level data.

The current best estimate is combined with other color or audio frequency information to generate values to present to the user. It is also possible to take advantage of correlation to interpolate missing values. For example, a pixel 12 that is currently being worked on is P5. An array of pixel values (YCbCr) is present, just before converting to RGB for display on a screen. Pixels that have already been decoded have greater accuracy as all the data for their reconstruction is available, pixels P4 and P6, for example. Complete data for all decomposition levels in the Y component of P4 and P6 is present. If P5's Y component has been reconstructed with data from P5Y0, P5Y1 and P5Y2 with missing data in P5Y3 and P5Y4, but P4 and P6 have complete Y components, then, due to the spatial relationships found among neighboring pixels in video, it may be appropriate to adjust the Y level of P5 based on the more accurate Y levels in P4 and P6. This process identifies a pixel for which the pixel data is not fully reconstructed and interpolates the pixel data for the identified pixel from pixel data for adjacent pixels.

The amount of blending to perform and how many neighboring pixels from which to sample, will be dependent on the amount of spare computation time there is during playback. As this step depends on values from other pixels, it cannot be carried out in parallel like the bulk of the computation. Output must be placed into an additional buffer to avoid contaminating the source data during the evaluation of neighboring pixels. Other nearby pixels (for example, P2 and P8, and to a lesser degree P1, P3, P7 and P9) provide further sources for blending with P5. The values of these neighboring pixels in previous and future frames can also be sampled. Neighbors even further afield in time and space can be used with appropriate weightings based on their own accuracy and distance from the target pixel. Blending is performed in the YCbCr space as interpolating these values is generally more visually pleasing than making these adjustments on the final RGB values. As further data arrives, the detail and accuracy of the decoding is higher for a greater proportion of the pixels on screen.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of processing a video stream comprising a plurality of sequential frames of pixels, comprising:
for each pixel in a frame, extracting, with a processor, a pixel data stream comprising color components of each specific pixel from each frame;
for each said pixel data stream, performing, with said processor, a transformation, thereof, into a plurality of detail components;
from each transformed pixel data stream, collecting, with said processor, a detail component defining a lowest level of detail for a respective pixel data stream;
storing, sequentially in a primary block, the collected lowest level of detail components; and
generating at least one additional block containing remaining detail components.

2. The method of claim 1, further comprising, for each said pixel data stream, prior to performing said transformation, thereof, into a plurality of detail components, converting said color components of each said pixel to a luminance and chrominance format.

3. The method of claim 2, wherein for each said pixel data stream, said performing said transformation of each said pixel data stream into a plurality of detail components, comprises performing successive discrete wavelet transforms on each said pixel data stream.

4. The method of claim 3, further comprising storing, in said primary block, metadata comprising information relating to an original video stream.

5. The method of claim 4, further comprising:
receiving an audio stream;
separating the audio stream into frequency limited streams;
performing, for each of said frequency limited streams, a transformation of each of said frequency limited streams into a plurality of audio detail components;
collecting, from each said transformed frequency limited streams, an audio detail component defining a lowest level of audio detail for a respective frequency limited stream;
storing, in said primary block, the collected lowest level of audio detail components; and
generating at least one additional block containing remaining audio detail components.

6. The method of claim 5, further comprising, prior to generating at least one additional block containing said remaining detail components and said remaining audio detail components, compressing said remaining detail components and said remaining audio detail components to remove data redundancy.

7. A system for processing a video stream comprising a plurality of sequential frames of pixels, the system comprising a processor arranged to:
extract, for each pixel in a frame, a pixel data stream comprising color components of each specific pixel from each frame;
perform, for each pixel data stream, a transformation of said each pixel data stream into a plurality of detail components;
collect, from each transformed pixel data stream, a detail component defining a lowest level of detail for a respective pixel data stream;
store sequentially, in a primary block, the collected lowest level of detail components; and
generate at least one additional block containing remaining detail components.

8. A computer program product for processing a video stream comprising a plurality of sequential frames of pixels, the computer program product comprising a computer readable storage medium having computer readable program code embodied therewith, the computer readable program code comprising:
computer readable program code configured to extract, for each pixel in a frame, a pixel data stream comprising color components of each specific pixel from each frame;
computer readable program code configured to perform, for each pixel data stream, a transformation of said each pixel data stream into a plurality of detail components;
computer readable program code configured to collect, from each transformed pixel data stream, a detail component defining a lowest level of detail for a respective pixel data stream;
computer readable program code configured to store, sequentially in a primary block, the collected lowest level of detail components; and
computer readable program code configured to generate at least one additional block containing remaining detail components.

9. A method of producing a video stream comprising a plurality of sequential frames of pixels, comprising:
receiving a primary block storing sequentially a lowest level of detail components and at least one additional block containing remaining detail components;
constructing, with a processor, a plurality of transformed pixel data streams, each comprising a lowest level of detail component and at least one remaining detail component;
performing, with said processor, for each transformed pixel data stream, an inverse transformation of said each transformed pixel data stream into a pixel data stream comprising color components of each specific pixel from each frame; and
generating, with said processor, a frame by extracting from each pixel data stream pixel data for each specific frame.

10. The method of claim 9, wherein performing, for each transformed pixel data stream, an inverse transformation of the transformed pixel data stream into a pixel data stream, comprises performing successive inverse discrete wavelet transforms on each transformed pixel data stream.

11. The method of claim 10, further comprising extracting from said primary block, metadata comprising information relating to an original video stream, and operating said constructing and said performing in accordance with said extracted metadata.

12. The method of claim 11, further comprising:
extracting from said primary block a lowest level of audio detail component and at least one additional block containing remaining audio detail components;
constructing a plurality of transformed frequency limited streams, each comprising a lowest level of audio detail component and at least one audio remaining detail component;
performing, for each transformed frequency limited stream, an inverse transformation of the transformed frequency limited stream into a frequency limited stream; and
generating an audio output by combining the frequency limited streams.

13. The method of claim 12, wherein constructing a plurality of transformed pixel data streams, each comprising a lowest level of detail component and at least one remaining detail component, further comprises identifying that at least one remaining detail component is missing and replacing the at least one missing detail component with a run of zeros.

14. The method of claim 9, wherein generating a frame by extracting from each pixel data stream pixel data for each specific frame further comprises identifying a pixel for which pixel data is not fully reconstructed and interpolating said pixel data for an identified pixel from pixel data for adjacent pixels.

15. A system for producing a video stream comprising a plurality of sequential frames of pixels, the system comprising a processor arranged to:
receive a primary block storing sequentially a lowest level of detail components and at least one additional block containing remaining detail components;
construct a plurality of transformed pixel data streams, each transformed pixel data stream comprising a lowest level of detail component and at least one remaining detail component;
perform, for each transformed pixel data stream, an inverse transformation of each said transformed pixel data stream into a pixel data stream comprising color components of a specific pixel from each frame; and
generate a frame by extracting from each pixel data stream pixel data for a specific frame.

16. A computer program product for producing a video stream comprising a plurality of sequential frames of pixels, the computer program product comprising a computer readable storage medium having computer readable program code embodied therewith, the computer readable program code comprising:
computer readable program code configured to receive a primary block storing sequentially a lowest level of detail components and at least one additional block containing remaining detail components;
computer readable program code configured to construct a plurality of transformed pixel data streams, each comprising a lowest level of detail component and at least one remaining detail component;
computer readable program code configured to perform, for each transformed pixel data stream, an inverse transformation, thereof, into a pixel data stream comprising color components of a specific pixel from each frame; and
computer readable program code configured to generate a frame by extracting from each pixel data stream, pixel data for a specific frame.
